(19) United States
(12) Patent Application Publication
(10) Pub. No.: US 2010/0018599 A1
(43) Pub. Date: Jan. 28, 2010

(54) Double wall duct system

(75) Inventors: Jesus Lopez Ferrer, Madrid (ES); Jose Luis Marcos Montes, Madrid (ES)

Correspondence Address: LADAS & PARRY LLP, 26 WEST 61ST STREET, NEW YORK, NY, 10023, US

(73) Assignee: EADS CONSTRUCCIONES AERONAUTICAS, S.A.

(21) Appl. No.: 12/218,952

(22) Filed: Jul. 18, 2008

(30) Foreign Application Priority Data
Apr. 25, 2008 (ES) 200801199

(51) Int. Cl. F16L 9/14; B23P 19/04

(52) U.S. Cl. 138/112; 138/148; 72/324; 29/455.1; 219/117.1; 138/104

(57) ABSTRACT

The invention relates to a double wall duct system (1) suitable for carrying fluids to at least other system comprising an internal duct (3) for conveying the fluid and an external duct (2) for conveying a potential leakage in the system (1), the double wall duct system (1) also comprising a clearance (8) between the ducts (2, 3) and at least one bend, the system (1) also comprising at least one bushing (4, 5) that connects the system (1) to at least other system, the bushing (4, 5) being slidable in the system (1) before being connected to the system (1) and to other systems, the inner duct (3) being connectable at its ends to other systems and the outer duct (2) being connectable to one end of the bushing (4, 5), the bushing (4, 5) providing a closed structural integrity of the system (1) therefore allowing a potential leakage in the double wall system (1) to be detected and evacuated in a controlled manner. The invention also relates to a method of manufacturing such a double wall duct system (1).

### FIELD OF THE INVENTION

The present invention relates to a double wall duct system, in particular to be used in the aeronautical field, and to a method of manufacturing such a double wall duct system.

### BACKGROUND OF THE INVENTION

Double wall ducts are typically used in the aeronautical field in areas where a potential leakage may jeopardize the continuity of a safe flight, therefore causing possible injuries to the related personnel due to vapors hazards.

In the case of double wall ducts used in the aeronautical field, comprising an internal duct and an external duct, the internal duct is used for bearing fuel pressures, while the external duct is used to convey potential leakages to a specific drain system outside the risk area, this constituting a situation of a special risk in the aeronautical field.

There exist known methods of fabricating double wall ducts, like for example the one described in document U.S. Pat. No. 4,332,073, where a method for manufacturing a double wall duct made of composite material is disclosed. The outer duct is expanded by heating, whereas the inner duct is contracted by cooling, therefore being the two ducts introduced one inside the other. After this, the clearance between the two ducts disappears and they are brought to the same dimension. No bending in the duct is disclosed in this document, and no clearance is kept between the two ducts. The problem raised by the method of this document is that it is expensive and not valid for fabricating bends. Moreover, as there is no clearance kept between the two ducts, potential leakages are therefore not controlled.

Document U.S. Pat. No. 5,189,790 discloses a method of manufacturing a double walled duct elbow by the use of seal plugs to be used in car exhaust gas manifolds. The main problem raised in this method is that its fabricating costs are quite high, as the diameter of both ducts has to be the same and this diameter must also be of a very specific dimension. Moreover, the material of the ducts is very expensive, as the fabricating method comprises the step of blowing by pressure, the material needing therefore to bear such high pressures. In the junctions, the double wall duct of this document does not have any clearance between the two ducts: the double wall duct is then not valid for controlling or detecting potential leakages.

Document U.S. Pat. No. 5,054,185 discloses a method for fabricating a double wall duct comprising an inner and an outer duct, also comprising an intermediate layer with a material for attenuating vibrations, to be particularly used in automobile exhaust systems. The material for attenuating vibrations of this invention means weight and is therefore something to be considered as highly negative in the aeronautical field. Also, the method of this invention does not maintain a clearance between the ducts, necessary for the detection and control of leakages. The problem solved by this invention is that of noise in a double wall duct. This invention does not solve, on the other hand, the problem of structural integrity in double wall ducts caused by vibrations.

Document U.S. Pat. No. 3,201,861 discloses a method for forming a tubular double wall exhaust duct element, comprising an outer duct element and an inner duct element comprising orifices spaced along its length, for acoustic reasons, such that there exists a gap between the outer and the inner duct, all along the length of the duct except at the ends. These orifices would produce uncontrolled leakages when used for conveying fluids; moreover, the costs of this method are high.

Document U.S. Pat. No. 5,497,809, upon which the preamble of claim 1 is based, discloses a coaxial tubing system comprising bending sleeves of an insoluble, compression resistant material with cold flow characteristics, longitudinal fluid passageways being provided between the tubes. Conductive spacers are also provided for maintaining annular tube spacing, particularly at tube ends. The main problem of this invention is that the compression resistant material increases the system weight, which is of particular relevance in the aeronautical field.

The main problem and difficulty when using the double wall duct manufacturing processes as described above comes where low weight and small area is available to route such ducting systems, as it happens when used in the aeronautical field, therefore being these processes non-viable.

The present invention is oriented to the solution of these drawbacks.

### SUMMARY OF THE INVENTION

The invention is intended to provide a double wall duct system and a method for such a double wall duct system manufacturing, the double wall duct system preferably been made of a metallic material and comprising an external duct used to convey potential leakages and an internal duct used for bearing fuel pressures. The method according to the invention comprises bending both the internal and the external ducts together, and welding afterwards said internal and external duct to a fitting devoted to support the double wall duct system and/or to connect said double wall duct system to other similar duct systems.

The objective of the present invention is therefore to provide a double wall duct system, particularly metallic, to be used preferably in those areas of an aircraft where special precautions are needed (fuselage, areas adjacent to fire zones, etc.) and to provide a method for manufacturing such double wall duct system.

The manufacturing method of the present invention allows bending the inner duct and the outer duct of a double wall duct together, therefore eliminating the need for additional outer shell welding and keeping a clearance or gap in between the inner duct and the outer duct to avoid fretting that may cause non-detectable damages.

The manufacturing method of the invention comprises the following steps:
a) both the inner and the outer ducts are cut to a bigger dimension than the one finally required of the system, prior to the bending step;
b) a stopper, preferably conic, is placed in one of the ends of the double wall duct assembly;
c) the clearance or gap in between both inner and outer ducts is filled with a filler material, such as Corundum, by using a special tool, to ensure and homogeneous bending by balancing the loads that appear and at bending process;
d) an additional stopper is then placed at the other end of the double wall duct assembly;
e) the double wall duct assembly is then bent, by using standard tools and machines for tube bending;
f) the double wall duct is then cut to its final dimension and the filler material is removed.

Once the bending procedure as described above is finished, the double wall duct system is then welded to a fitting devoted to its support by welding the inner duct and then the outer duct, using a bushing according to the invention and designed to fit the double wall duct system to the required fitting in particular, this bushing having previously been inserted surrounding the external duct of the double wall duct system. The bushing can either be straight or conic, depending on the fitting size to which the double wall duct system is to be connected.

Other features and advantages of the present invention will be disclosed in the following detailed description of an illustrative embodiment of its object in relation to the attached figures.

### DESCRIPTION OF THE DRAWINGS

The features, objects and advantages of the invention will become apparent by reading this description in conjunction with the accompanying drawings, in which:

FIG. 1 shows a general view of a double wall duct system of the present invention.

FIG. 2 shows both ducts, inner duct and outer duct, prior to the start of the manufacturing method according to the invention.

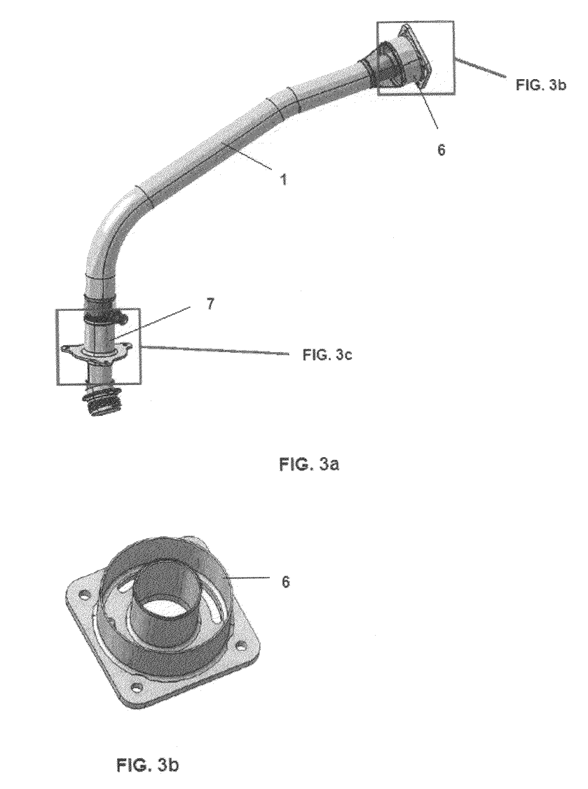

FIGS. 3a, 3b and 3c show details of the fittings to which the double wall duct system according to the invention is connected, FIG. 3b showing a detail of a wing connection fitting being the double wall duct system of the invention connected to another double wall duct system, and FIG. 3c showing a detail of a firewall connection fitting, being the double wall duct system of the invention connected to a single wall duct system.

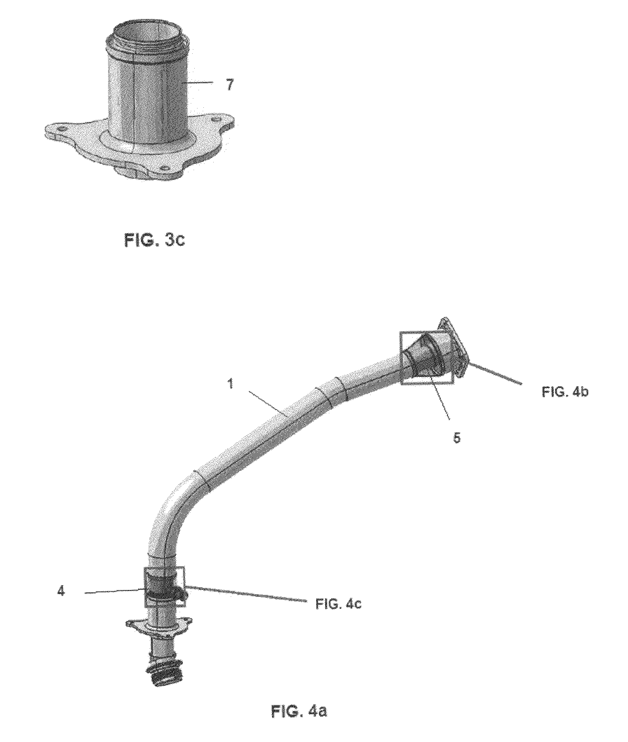

FIGS. 4a, 4b and 4c show details of sliding bushings used for the welding procedure of a double wall duct system according to the invention, FIG. 4b showing a detail of a conical bushing for a wing connection fitting, and FIG. 4c showing a detail of a straight bushing for a firewall connection fitting.

FIGS. 5a, 5b and 5c show details of the assembly of both inner and outer ducts together with a conical stopper for the manufacturing of a double wall duct system according to the invention.

FIG. 6 shows the filling operation and the tool used for the manufacturing of a double wall duct system according to the invention.

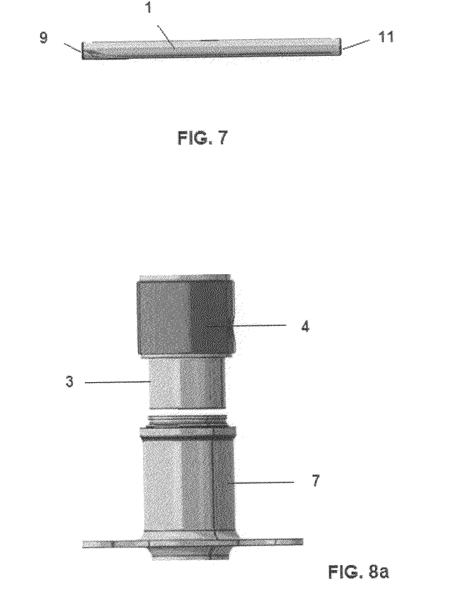

FIG. 7 shows the complete assembly prior to the bending operation for the manufacturing of a double wall duct system according to the invention.

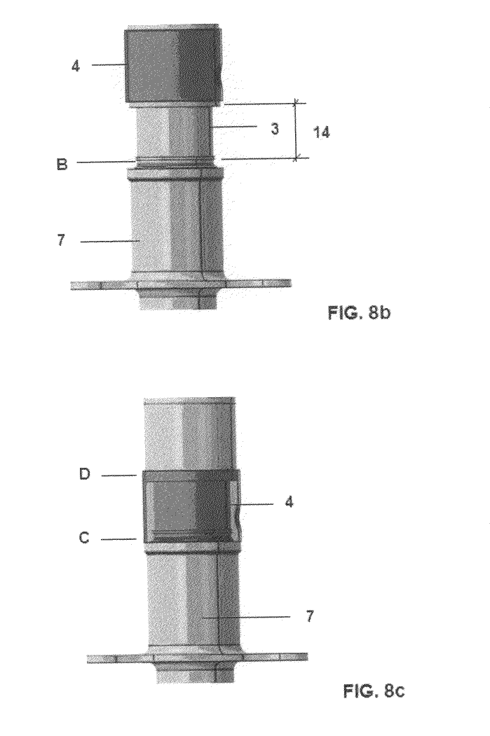

FIGS. 8a, 8b and 8c show details of the steps of the welding operation for a double wall duct system according to the invention.

FIGS. 9a, 9b and 9c show details of the steps of the welding operation at the other end of the assembly of a double wall duct system according to the invention.

### DETAILED DESCRIPTION OF THE INVENTION

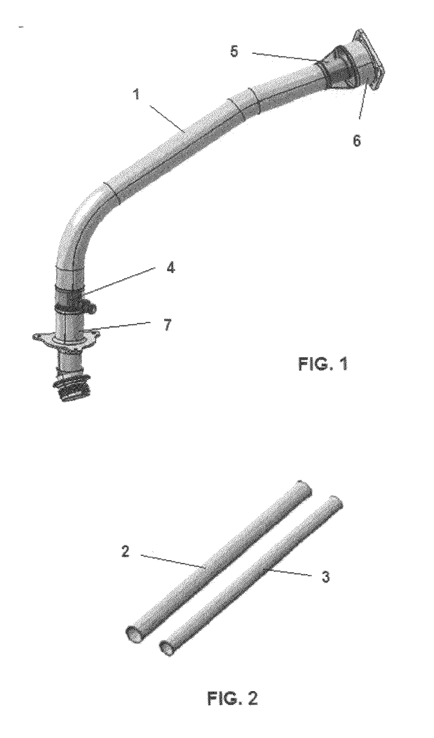

The invention is therefore intended to provide a double wall duct system 1, preferably being made of a metallic material, and a method for such a double wall duct system 1 manufacturing. The double wall duct system 1 comprises an external duct 2, used to convey potential leakages, and an internal duct 3, used for bearing fuel pressures. It is to be noted that these two ducts, 2 and 3, are of standard commercial dimensions: this represents another advantage of the invention, as no additional cost are to be added because of ducts of special diameters. The double wall duct system of the invention and its method of manufacturing keeps a clearance between the two ducts, 2 and 3, therefore being the manufacturing costs maintained. The method according to the invention comprises bending both the internal duct 3 and the external duct 2 together, and welding afterwards said internal 3 and external duct 2 to a fitting 6, 7 devoted to support the double wall duct system 1 and/or to connect said double wall duct system 1 to other duct systems that can also be similar to system 1. As schematically illustrated in FIG. 1, the process for manufacturing a double walled duct system 1 according to the invention consists of assembling two ducts 2, 3 of a different diameter one inside each other before a bending operation, and welding said ducts 2, 3 together via a series of sliding bushings 4, 5 to conform finally the said double wall duct system 1. The bushings 4, 5 can either be conical or straight.

The inner duct 3 and the outer duct 2 conforming the double wall duct system 1 are preferably made of a metallic material, such as Stainless Steel, preferably AISI 321, although the invention is also applicable to a variety of metallic materials.

The manufacturing method of the present invention allows bending the inner duct 3 and the outer duct 2 of a double wall duct system 1 together, therefore eliminating the need for additional outer shell welding and keeping a clearance or gap 8 in between the inner duct 3 and the outer duct 2 to avoid fretting that may cause non-detectable damages.

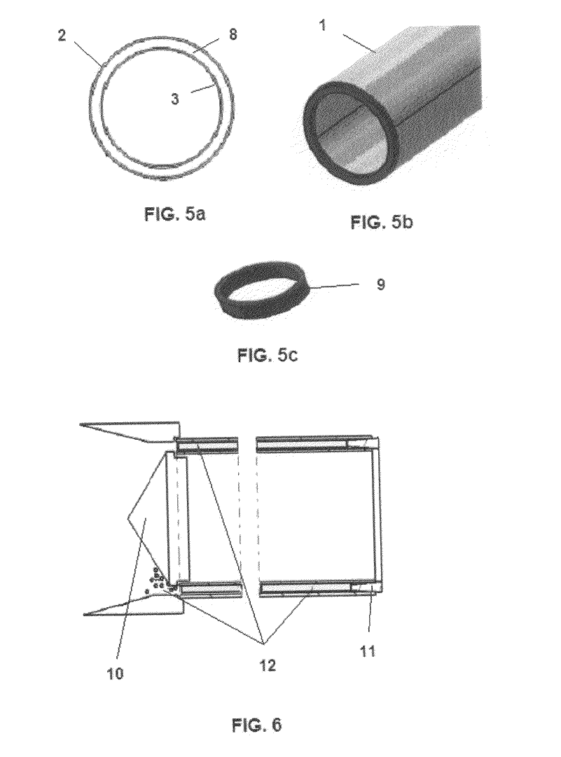

The process for the manufacturing of a metallic double wall duct system 1 of FIG. 1, said double wall duct system 1 being of any geometry to be used for carrying fluids where a leakage shall be detected and/or evacuated in a controlled manner, comprises the following steps:
a) both the inner duct 3 and the outer duct 2 are cut to a bigger dimension than the one finally required of the double wall duct system 1;
b) the ducts 2 and 3 are cleaned, and the edges of each of its ends are prepared;
c) the inner duct 3 is introduced into the outer duct 2;
d) a stopper 9, preferably conical for making it easier to be inserted into the double wall duct system 1, as the one showed in FIG. 5c, is placed by pressure in one of the ends of the double wall duct system 1 assembly;
e) the duct system 1 is placed in a not horizontal position, preferably vertically, with the stopper 9 being placed in its down part;
f) the clearance or gap 8 in between both inner duct 3 and outer duct 2 is filled with a filler material 12, this filler material 12 being able to flow in a controlled manner, i.e., performing a certain resistance to the flowing but without abrading the walls of the ducts 2, 3, such as Corundum material, also providing a medium to keep substantially parallel surfaces on ducts 2 and 3 by using a special tool 10, preferably with the shape of a funnel, to facilitate the insertion of the filler material 12 in the clearance 8, therefore ensuring an homogeneous bending of both ducts, 2 and 3, by a balanced transfer of the loads that appear in the bending process from the outer duct 2 to the internal duct 3;
g) one the gap 8 between the ducts 2 and 3 has been filled and the filler 12 has been properly compacted, an additional stopper 11 is then placed by pressure at the other end of the double wall duct system 1 assembly;
h) the double wall duct system 1 assembly is then bent, by using standard tools and machines for tube bending;
i) both stoppers 9 and 11, as well as the filler material 12, such as corundum, are removed, once the bending process has finished;
j) a cleaning, manual or not, is then performed;
k) the double wall duct system 1 obtained is then cut in its ends to its final dimension;
l) the sliding bushings, 4 and 5, are installed in the ends of the double wall duct system 1;
m) the double wall duct 1 is de-burred and prepared for welding;
n) welding, such as TIG, orbital or manual welding, is then performed in machined fittings, 6 and 7;
o) welding, such as TIG, orbital or manual welding, is performed in sliding bushings, 4 and 5;
p) final inspection and testing occurs.

The manufacturing of the machined fittings, 6 and 7, is performed following a standard known procedure. The manufacturing of the sliding bushings 4 and 5, which are preferably made of a metal which is compatible as to welding with the double wall duct system 1 and with the fittings 6 and 7, is also performed following a standard known procedure. The bushings 4 and 5 can either be conical, straight or of any appropriate shape to fit the system 1 to the other systems.

Both fittings, 6 and 7, are machined preferably from steel material, for example of the type CRES 321. The bushings 4 and 5 are also preferably made of steel material of the type CRES 321.

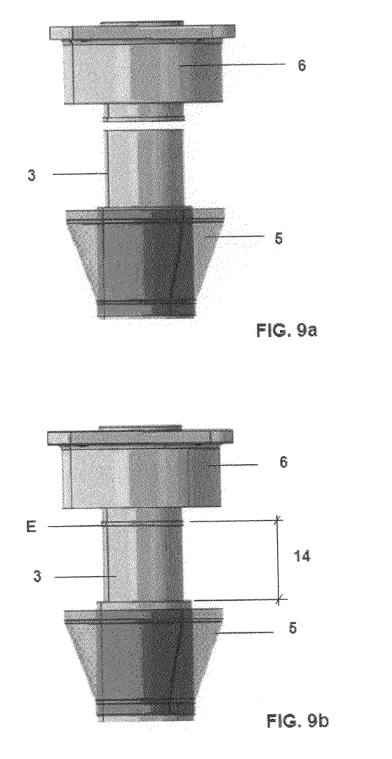

The welding operation for a double wall duct system 1 comprises, as can be seen in FIGS. 8a, 8b and 8c, the following steps: first the bushing 4, which is connected to the firewall connection fitting 7, is introduced in one end of the double wall duct system 1, then the inner duct 3 is welded in part B of FIG. 8b, and afterwards, the outer duct 2 is welded in parts C and D of FIG. 8c.

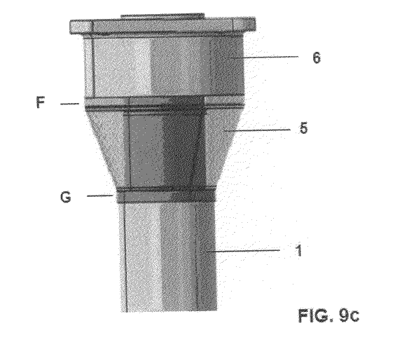

The welding operation at the other end of the double wall duct system 1 comprises, as can be seen in FIGS. 9a, 9b and 9c, the following steps: first the bushing 5 (in these Figures the bushing 5 has been made in a conical shape), which is connected to the wing connection fitting 6, is introduced in the other end of the double wall duct system 1, then the inner duct 3 is welded in part E of FIG. 9b, and afterwards, the outer duct 2 is welded in pats F and G of FIG. 9c. The full assembly is then completed.

The method according to the invention comprises welding first the inner duct 3, then sliding the bushing 4 or 5, which has previously been introduced in the double wall duct system 1, and one the bushing is displaced, it is welded in two parts to the system 1.

One of the main advantages of the present invention is to provide a double wall duct system 1 connected to other systems by fittings 6 and 7 with at least one bending, such that the system 1 is formed in a single process, and is not formed by different parts, each one of the parts being formed in different processes, therefore having the advantages of maintaining a low weight where a small area is available to route the ducting systems, as it happens in the aeronautical field of the present invention.

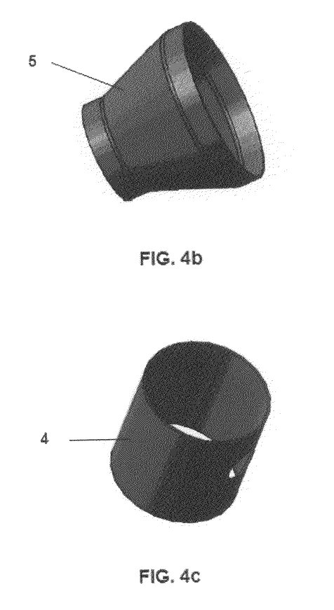

The bushings, 6 or 7, can also comprise a drain port, as the one showed in bushing 4 of FIG. 4a.

In FIG. 8b, it can be observed that the distance or gap 14 from the bushing 4 and the part B in which the welding is to be performed, has to meet a minimum, such that the welding machine or tool to be used can perform such welding in B. The same can be said for FIG. 9b, relative to the distance or gap 14 between the bushing 5 and the part E in which the welding is to be performed.

The bushings 4, 5 provide a closed structural integrity of the system 1, therefore allowing a potential leakage in the double wall system 1 to be detected and evacuated in a controlled manner.

Although the present invention has been fully described in connection with preferred embodiments, it is evident that modifications may be introduced within the scope thereof, not considering this as limited by these embodiments, but by the contents of the following claims.

1. Double wall duct system (1) suitable for carrying fluids to at least other system comprising an internal duct (3) for conveying the fluid and an external duct (2) for conveying a potential leakage in the system (1), the double wall duct system (1) also comprising a clearance (8) between the ducts (2, 3) and at least one bend, characterized in that it also comprises at least one bushing (4, 5) that connects the system (1) to at least other system, the bushing (4, 5) being slidable in the system (1) before being connected to the system (1) and to other systems, the inner duct (3) being connectable at its ends to other systems and the outer duct (2) being connectable to one end of the bushing (4, 5), the bushing (4, 5) providing a closed structural integrity of the system (1) therefore allowing a potential leakage in the double wall system (1) to be detected and evacuated in a controlled manner.

2. Double wall duct system (1) suitable for carrying fluids according to claim 1 characterized in that the inner duct (3) and the outer duct (2) are fixed in the system (1) by welding.

3. Double wall duct system (1) suitable for carrying fluids according to claim 1 characterized in that the bushing (4, 5) is slidable in the system in such a manner that a gap (14) is provided between the end of the bushing (4, 5) and the end (B, E) of the internal duct (3), to facilitate the connection of the internal duct (3) to the at least other system.

4. Double wall duct system (1) suitable for carrying fluids according to claim 3 characterized in that the gap (14) is suitable for using a welding machine.

5. Double wall duct system (1) suitable for carrying fluids according to claim 1 characterized in that the ducts (2, 3) are of standard commercial dimensions.

6. Double wall duct system (1) suitable for carrying fluids according to claim 1 characterized in that the material of system (1) is a metallic material.

7. Double wall duct system (1) suitable for carrying fluids according to claim 5 characterized in that the material of the bushings (4, 5) is a metallic material.

8. Method of manufacturing the double wall duct system (1) of claim 1 characterized in that it comprises the following steps:
a) cutting the inner duct (3) and the outer duct (2) to a bigger dimension than the one finally required of the system (1);
b) introducing the inner duct (3) in the outer duct (2);
c) filling the clearance (8) with a filler material (12) to keep substantially parallel surfaces on ducts (2, 3);
d) bending the double wall duct system (1);
e) removing the filler material (12);
f) cutting the ends of the system (1) to its final dimension;
g) installing the bushings (4, 5) in the ends of the system (1);
h) closing the ends of the outer duct (2) and the inner duct (3);
i) sliding and fixing the bushings (4, 5).

9. Method of manufacturing a double wall duct system (1) according to claim 8 characterized in that the filler material (12) is a material able to flow in a controlled manner, performing a certain resistance to the flowing but without abrading the walls of the ducts (2, 3).

10. Method of manufacturing a double wall duct system (1) according to claim 9 characterized in that the filler material (12) is Corundum material.

11. Method of manufacturing a double wall duct system (1) according to claim 8 characterized in that it also comprises the step of introducing a stopper (9) in one of the ends of the system (1), so that the system (1) can then be placed in a not horizontal position for the introduction of the filler material (12).

12. Method of manufacturing a double wall duct system (1) according to claim 11 characterized in that it also comprises the step of introducing an additional stopper (11) in the other end of the system (1) so that the bending of the system (1) occurs.

13. Method of manufacturing a double wall duct system (1) according to claim 8 characterized in that the filler material (12) is introduced by a special tool (10) in the shape of a funnel to facilitate the insertion of the filler material (12) in the clearance (8).

14. Method of manufacturing a double wall duct system (1) according to claim 8 characterized in that the closing of the ends of the outer duct (2) and the inner duct (3) is performed by welding.

15. Method of manufacturing a double wall duct system (1) according to claim 14 characterized in that it the fixing of the bushings (4, 5) is performed by welding, such that it comprises the following steps:
a) once the ends of the outer duct (2) and the inner duct (3) have been closed by welding in their parts (B, E), the bushing (4, 5) slides in the system (1);
b) the bushing (4, 5) is then welded to the system (1) in respective parts (C, D and F, G).
